(19) United States
(12) Patent Application Publication
(10) Pub. No.: US 2017/0303122 A1
(43) Pub. Date: Oct. 19, 2017

(54) WIRELESS COMMUNICATION SYSTEM USING MIMICKED NEAR FIELD COMMUNICATION AND AUTHENTICATION METHOD THEREOF

(71) Applicant: National Tsing Hua University, Hsinchu City 300 (TW)

(72) Inventors: Pai-Hsiang Chou, Hsinchu City (TW); Wen-Tsuen Chen, Hsinchu City (TW); Wen-Chan Shih, Hsinchu City (TW); Cheng-Ting Lee, Hsinchu City (TW)

(21) Appl. No.: 15/347,026

(22) Filed: Nov. 9, 2016

(30) Foreign Application Priority Data
Apr. 13, 2016 (TW) 105111463

(51) Int. Cl. H04W 12/06; H04B 5/00; H04W 4/00; H04W 76/04

(52) U.S. Cl. CPC H04W 12/06; H04W 76/046; H04B 5/0031; H04W 4/008

(57) ABSTRACT

A wireless communication system using mimicked near field communication is disposed in a peripheral application device and configured to be connected with a mobile device. The system includes a wireless communication module configured to send a control command, and an RF switching circuit configured to be switched to a low or normal power mode according to the control command. Under the low power mode, a signal attenuation unit of the RF switching circuit attenuates a frequency of a transmission signal emitted from the wireless communication module to generate an output signal. Under the normal power mode, the signal attenuation unit maintains the frequency of the transmission signal. The signal frequency is allowed to be attenuated during an authentication phase to thereby achieve near field communication, and an original wireless transmission mechanism is allowed to be used after authentication is completed so as to perform operation of the peripheral application device.

### BACKGROUND OF THE INVENTION

### 1. Field of the Invention

The present invention relates to wireless communication technologies, and, more particularly, to a wireless communication system using mimicked near field communication for device authentication and an authentication method of the wireless communication system.

### 2. Description of Related Art

As mobile devices become popular, more and more peripheral applications are developed around the mobile devices, and wireless communication mechanisms (for example, Bluetooth) with high compatibility and low power consumption are used for direct communication between the mobile devices and the peripheral applications. For example, wearable devices and smart household electrical appliances generally have built-in Bluetooth Low Energy (BLE) modules so as to allow users to directly control the devices, thus improving the use convenience and reducing the hardware cost.

Generally, to enable a mobile device to control a peripheral application device through a BLE module, the mobile device must be connected with the peripheral application device. To establish such a connection, a set of pairing codes are generally sent by the peripheral application device. When the correct pairing codes are received by the mobile device, the mobile device and the peripheral application device are paired. At this point, the mobile device can be used to control the peripheral application device. Although pairing codes facilitate to improve the safety, since electromagnetic signals are transmitted all around during a pairing process, pairing packets are easily to be captured, analyzed and cracked by others. Therefore, near field communication (NFC) is widely used to improve the pairing safety.

In the near field communication, two devices are close to each other within a predetermined distance for authentication. Therefore, the near field communication is much safer than general wireless communication mechanisms. However, the near field communication has a low transmission frequency and needs a larger induction coil, thus consuming a lot of space when integrated with other systems and hindering miniaturization of electronic products. Further, NFC reader chips need to be equipped with a supported operating system for operation and thus have a limited application field.

Therefore, how to overcome the above-described drawbacks has become critical.

### SUMMARY OF THE INVENTION

In view of the above-described drawbacks, the present invention provides a wireless communication system that can mimic near field communication under a current communication mode for device authentication. As such, the wireless communication system performs near field communication during an authentication phase, and goes back to the normal communication mode to maintain connection between two devices after authentication is completed.

In order to achieve the above and other objects, the present invention provides a wireless communication system using mimicked near field communication, wherein the wireless communication system is disposed in a peripheral application device and configured to be connected with a mobile device. The wireless communication system comprises: a wireless communication module configured to send a control command; and an RF switching circuit connected to the wireless communication module and configured to be switched to a low power mode or a normal power mode according to the control command In an embodiment, the RF switching circuit comprises a signal attenuation unit. Under the low power mode, the signal attenuation unit attenuates a frequency of a transmission signal emitted from the wireless communication module to generate an output signal, and under the normal power mode, the signal attenuation unit maintains the frequency of the transmission signal.

In an embodiment, the signal attenuation unit comprises a plurality of signal attenuators configured to provide different frequency attenuations to attenuate the transmission signal.

In an embodiment, the RF switching circuit further comprises a first switcher disposed before the signal attenuation unit and configured to receive the transmission signal emitted from the wireless communication module. In another embodiment, the RF switching circuit comprises a second switcher disposed after the signal attenuation unit configured to output the transmission signal that already passes through the signal attenuation unit.

In an embodiment, the output signal is transmitted to the mobile device through an antenna of the peripheral application device.

The present invention further provides an authentication method of a wireless communication system using mimicked near field communication. The wireless communication system is disposed in a peripheral application device and configured to be connected with a mobile device. The authentication method comprises steps of: switching the wireless communication system to a low power mode; sending, by the wireless communication system, an inquiry signal under the low power mode; receiving the inquiry signal, and sending, by the mobile device, a confirmation signal back to the wireless communication system; receiving the confirmation signal, switching the wireless communication system to a normal power mode; and performing, by the wireless communication system and the mobile device, data transmission or control.

In an embodiment, before the wireless communication system is connected to the mobile device, the wireless communication system is switched between the low power mode and the normal power mode periodically. The wireless communication system does not return to be switched between the low power mode and the normal power mode periodically until the wireless communication system is not connected to the mobile device.

In an embodiment, the wireless communication system comprises a signal attenuation unit configured to attenuate a frequency of a transmission signal emitted from the wireless communication system under the low power mode.

In an embodiment, the step of performing data transmission or control comprises: changing the wireless communication system from an authentication phase to a control phase so as to allow the mobile device to control the peripheral application device.

Therefore, by utilizing a control mechanism and hardware and software integration of the RF switching circuit, the present invention allows the RF switching circuit to choose whether to attenuate the frequency of a transmission signal emitted from the wireless communication system through a signal attenuation unit so as to achieve transmission of near distance communication. As such, privacy contents such as pairing codes or passwords can be protected from leakage or eavesdropping. That is, the low power mode is used for authentication during an authentication phase, and the normal power mode is used for data transmission or control after authentication is completed. Further, the wireless communication system according to the present invention is applicable to any wireless communication platform to achieve a low power communication function and a near distance transmission effect.

### BRIEF DESCRIPTION OF DRAWINGS

FIG. 1 is a schematic block diagram of a wireless communication system using mimicked near field communication according to the present invention;

FIG. 2 is a schematic diagram of an RF control circuit of the wireless communication system using mimicked near field communication according to an embodiment of the present invention;

FIG. 3 is a schematic flow diagram showing an authentication method of the wireless communication system using mimicked near field communication according to the present invention;

FIG. 4 is a graph showing packet sending cycles of a peripheral application device according to the present invention;

FIG. 5 is a timing diagram showing an authentication mechanism of the peripheral application device according to the present invention; and

FIG. 6 is a schematic flow diagram showing switching of the RF switching circuit between an authentication phase and a control phase according to the present invention.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

It should be noted that all the drawings are not intended to limit the present invention. Various modifications and variations can be made without departing from the spirit of the present invention.

To achieve the purpose of transmission of near distance communication without greatly changing a current wireless communication mode, the present invention provides a switching mechanism. If the near distance communication is needed, for example, for authentication of two devices, a near field communication (NFC) transmission frequency is used for signal transmission; otherwise, the transmission frequency of the original wireless communication mode is maintained for signal transmission. As such, the present invention meets the demand for near distance communication without changing the current wireless communication mechanism.

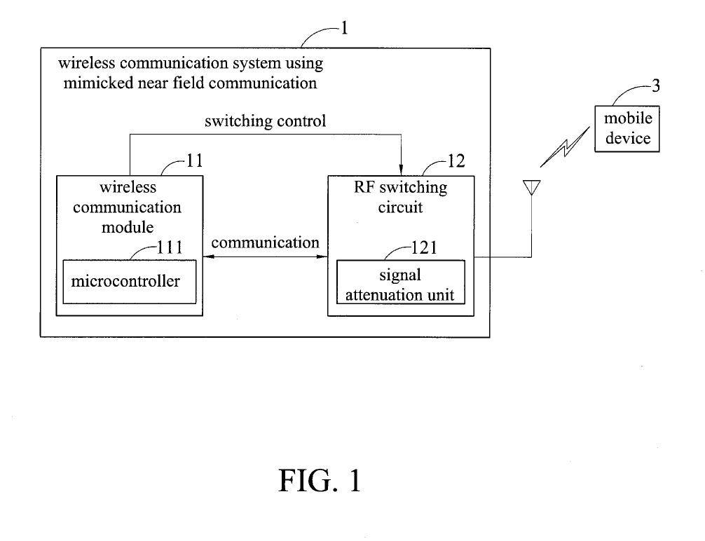

FIG. 1 is a schematic block diagram of a wireless communication system 1 using mimicked near field communication according to the present invention. The wireless communication system 1 using mimicked near field communication according to the present invention can be disposed in a peripheral application device, such as a smart household electrical appliance, a digital camera, a wearable device and so on. The wireless communication system 1 can be connected to a mobile device 3 so as to allow the peripheral application device to be controlled by the mobile device 3. The mobile device 3 can be, but not limited to, a mobile phone, a tablet or a notebook computer. The wireless communication system 1 comprises a wireless communication module 11 having a microcontroller 111, and an RF switching circuit 12.

The wireless communication module 11 sends a control command through the microcontroller 111. In an embodiment, the wireless communication module 11 can be a wireless communication chip such as Bluetooth, Zigbee or WiFi. The present invention does not change the current wireless communication mechanism. Therefore, the wireless communication module 11 is composes of a current wireless communication chip, and the microcontroller 111 inside the chip can send a control command (shown as a switching control in FIG. 1) to the RF switching circuit 12.

The RF switching circuit 12 is connected to the wireless communication module 11 and configured to be switched to a low power mode or a normal power mode according to the control command emitted from the wireless communication module 11. By switching between high and low frequencies, lower power transmission is performed during an authentication phase and high power transmission is performed after the wireless communication system 1 and the mobile device 3 are connected.

In an embodiment, the RF switching circuit 12 is controlled by a control command transmitted from the microcontroller 111 of the wireless communication module 11. Since this is a hardware control, this leads to a faster switching speed, compared with a software control. For example, the switching occurs in less than 100 ms every time.

In an embodiment, the RF switching circuit 12 comprises a signal attenuation unit 121. Under the low power mode, the signal attenuation unit 121 attenuates the frequency of a transmission signal emitted from the wireless communication module 11 to generate an output signal. Under the normal power mode, the signal attenuation unit 121 maintains the frequency of the transmission signal. After receiving the control command from the wireless communication module 11, the RF switching circuit 12 controls the signal attenuation unit 121 to attenuate the frequency of the transmission signal. The amount of attenuation can be adjusted according to the practical need.

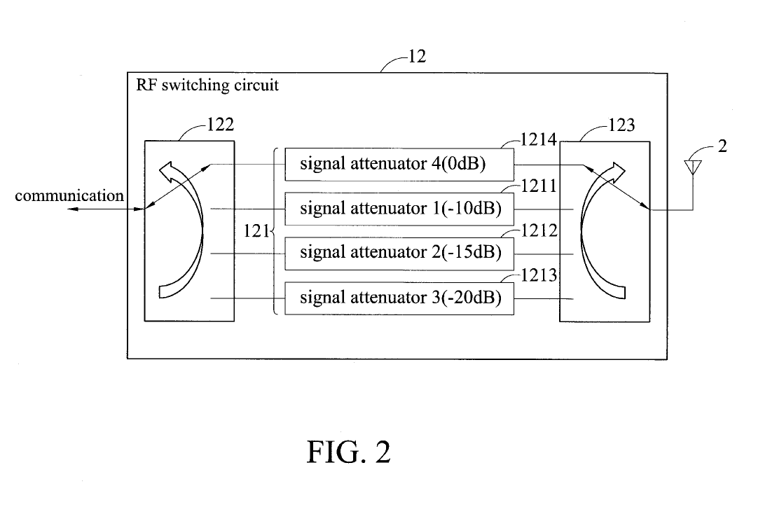

FIG. 2 is a schematic diagram of the RF switching circuit of the wireless communication system using mimicked near field communication according to an embodiment of the present invention. FIG. 2 illustrates how the transmission signal is attenuated by the RF switching circuit 12 of the wireless communication system 1. In the RF switching circuit 12, a first switcher 122 and a second switcher 123 are disposed before and after the signal attenuation unit 121, respectively. In an embodiment, the signal attenuation unit 121 has a plurality of signal attenuators. In an embodiment, the signal attenuation unit 121 has four signal attenuators 1211 to 1214 configured to provide various degrees of frequency attenuation.

The first switcher 122 disposed before the signal attenuation unit 121 is used to receive the transmission signal emitted from the wireless communication module 11 (shown in FIG. 1). The first switcher 122 can be a single input multiple output switcher. In an embodiment, the first switcher 122 is a 1 to 4 switcher. As such, after the transmission signal is received, four paths leading to the four signal attenuators 1211 to 1214, respectively, are provided for selection. The selection of the signal attenuators can be determined according to the practical need or a preset.

The signal attenuators 1211 to 1214 can provide various degrees of frequency attenuation. For example, the signal attenuator 1211 attenuates the frequency by 10 dB, the signal attenuator 1212 attenuates the frequency by 15 dB, the signal attenuator 1213 attenuates the frequency by 20 dB, and the signal attenuator 1214 makes no attenuation.

The second switcher 123 disposed after the signal attenuation unit 121 is used to output the transmission signal that already passes through the signal attenuation unit 121. The second switcher 123 can be a multiple input single output switcher. In an embodiment, the second switcher 123 is a 4 to 1 switcher. That is, the transmission signal received from one of the four attenuators 1211 to 1214 is further transmitted to the mobile device 3 (shown in FIG. 1) through an antenna 2 of the peripheral application device.

The first switcher 122 and the second switcher 123 can be, but not limited to, a 1 to 2 switcher and a 2 to 1 switcher, respectively. Further, the two switchers do not necessarily correspond to each other. For example, the first switcher 122 is a 1 to 4 switcher, and the second switcher 123 is a 2 to 1 switcher. As such, after the transmission signal passes through the first switcher 122, the first switcher 122 provides four paths for selection. After the transmission signal passes through the signal attenuation unit 121, the paths can be grouped in pairs so as to be outputted by the second switcher 123.

Although in an embodiment four signal attenuators are used and the attenuation values of the attenuators are 0 dB, 10 dB, 15 dB and 20 dB, respectively, the present invention is not limited thereto. Rather, the number of the attenuators or the attenuation values of the attenuators can be changed according to the design requirement.

According to the present invention, a current wireless communication module such as a BLE module is connected in series to an RF switching circuit, and a microcontroller of the wireless communication module is used to control the RF switching circuit to select a suitable path for transmission with a mobile device. In an embodiment, to allow transmission between the mobile device and a peripheral application device having the wireless communication system using mimicked near field communication, the system is switched to an authentication phase first. At this point, the mobile device needs to be moved close to the peripheral application device for authentication. After the authentication succeeds, the system switches to a control phase so as to allow the mobile device to control the peripheral application device.

The greatest difficulty in using a general wireless network to mimic Near Field Communication (NFC) transmission is that a signal can be received while two devices are not close to each other. That is, even if the general wireless network is reduced in power to mimic the near field communication, the distance between the two devices at which the signal can be received is 30 cm. According to the present invention, hardware and software are combined to adjust the power to such a degree that a signal can only be received when the distance between the devices is within several centimeters, thus mimicking the NFC transmission without replacing the current wireless network transmission.

The wireless communication module can be Bluetooth, Zigbee, WiFi and so on. The present invention allows privacy data to be communicated or switched within near distance so as to improve the communication safety. Also, low signal intensity facilitates to prevent privacy data such as pairing codes or passwords leakage or eavesdropping.

Further, the present invention achieves near distance communication without the need of an additional communication chip such as an NFC or RFID chip, thus greatly reducing cost of the peripheral application device, saving spaces, and reducing circuit layout complexity and power consumption of the system.

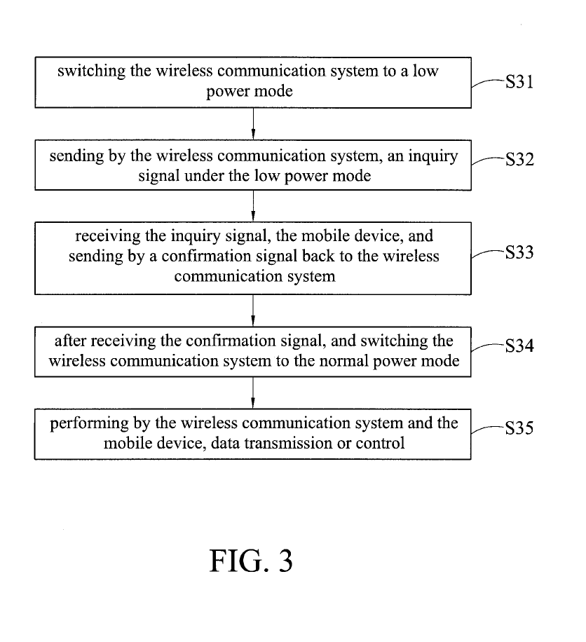

FIG. 3 is a schematic flow diagram showing an authentication method of the wireless communication system using mimicked near field communication according to the present invention. The authentication method illustrates how to establish a connection between a peripheral application device having the wireless communication system using mimicked near field communication according to the present invention and a mobile device, including an authentication phase before the connection and a control phase after the connection.

Referring to FIG. 3, at step S31 the wireless communication system is switched to a low power mode. In an embodiment, the peripheral application device is switchable between a low power mode and a normal power mode through the wireless communication system. The low power mode is used for the authentication phase, and the normal power mode is used for the control phase.

In an embodiment, the peripheral application device sends an inquiry mechanism to detect whether any mobile device want to be connect thereto. At this point, the wireless communication system sends an inquiry signal under the low power mode, so as to ensure the switched pairing codes or passwords cannot be leakage or eavesdropping before the connection.

At step S32, the wireless communication system sends the inquiry signal under the low power mode. Under the low power mode, the frequency of the inquiry signal (such as a polling signal) is attenuated, and therefore the inquiry signal can only be received by the mobile device within near distance.

At step S33, after receiving the inquiry signal, the mobile device sends a confirmation signal back to the wireless communication system. At step S33, after the mobile device receives the inquiry signal from the adjacent peripheral application device, if the mobile device wants to be connected with the peripheral application device, the mobile device sends the confirmation signal such as ACK back to the wireless communication system. Since the mobile device and the peripheral application device are close to each other, the wireless communication system of the peripheral application device considers the mobile device eligible for connection.

At step S34, after receiving the confirmation signal, the wireless communication system is switched to the normal power mode. At step S34, the confirmation signal received by the wireless communication system means the authentication between the peripheral application device and the mobile device is completed, and the wireless communication system is switched to the normal power mode and is connected with the mobile device.

At step S35, the wireless communication system and the mobile device perform data transmission or control. As described at step S34, after the authentication between the peripheral application device and the mobile device is completed, the peripheral application device and the mobile device can perform data transmission or control under the normal power mode. In an embodiment, the wireless communication system changes from the authentication phase to the control phase so as to allow the mobile device to control the peripheral application device.

Therefore, under the low power mode, the wireless communication system of the peripheral application device continuously inquires whether there is a mobile device that needs a connection. Since the frequency of the signal is attenuated, the mobile device must be close enough to receive the signal, thus improving the data communication safety, particularly for pairing codes or passwords before connection. After authentication, the wireless communication system switches to the normal power mode, i.e., the original transmission mechanism of the wireless communication module of the wireless communication system. As such, the peripheral application device and the mobile device can be connected for data transmission or control.

In order to maintain the original transmission mechanism of the peripheral application device and also perform a transmission mechanism of mimicked near field communication, the wireless communication system is switched between the low power mode and the normal power mode periodically. Further, under the low power mode, the frequency of the transmission signal from the wireless communication system is attenuated by the signal attenuation unit disposed in the wireless communication system.

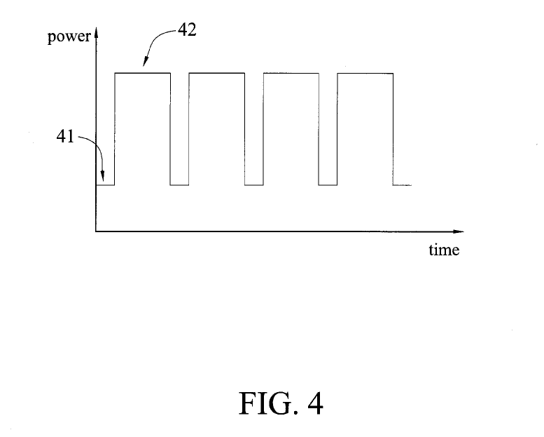

FIG. 4 is a graph showing packet sending cycles of the peripheral application device according to the present invention. Referring to FIG. 4, the low power mode 41 and the normal power mode 42 are alternately repeated. The ratio of the time duration of the low power mode 41 to the time duration of the normal power mode 42 can be determined according to the design requirement. That is, the wireless communication system is first switched to the low power mode 41 to perform inquiry. If no response is received, the wireless communication system is switched to the normal power mode 42 to perform work originally performed by the peripheral application device. As such, the present invention can not only maintain the original transmission mechanism, but also perform transmission of mimicked near field communication.

In an embodiment, when the wireless communication system using mimicked near field communication sends an inquiry packet, if an eligible mobile device is close to the wireless communication system, the mobile device can receive the inquiry packet and complete authentication. During the authentication phase, the RF switching circuit of the wireless communication system switches to a high attenuation path, i.e., the low power mode. Otherwise, when the wireless communication system is not in an authentication phase, it broadcasts packets, and the RF switching circuit is switched to a path without attenuation, i.e., the high power mode.

Further, if the wireless communication system and the mobile device are authenticated and connected, the wireless communication system does not return to be switched between the low power mode and the normal power mode periodically until the wireless communication system is not connected to the mobile device.

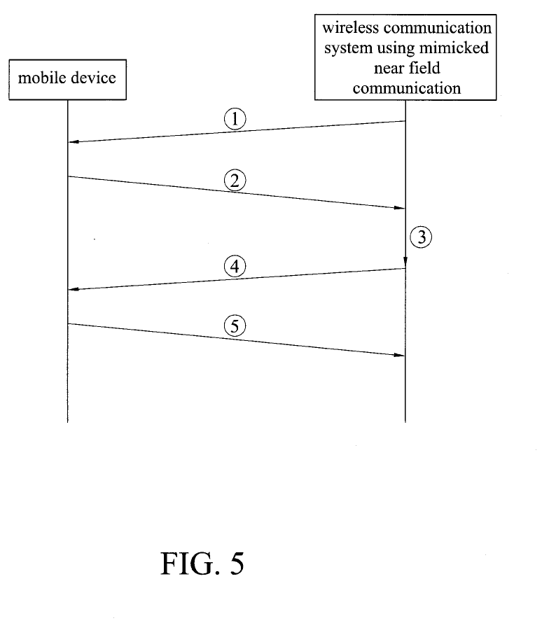

FIG. 5 is a timing diagram showing an authentication mechanism of the peripheral application device according to the present invention. FIG. 5 illustrates how to authenticate between the wireless communication system using mimicked near field communication inside the peripheral application device and a mobile device.

At step 1, the wireless communication system sends an inquiry packet at low power to enter into an authentication mode.

At step 2, a mobile device close to the peripheral application device, if receiving the inquiry packet, sends a confirmation packet ACK back to the wireless communication system.

At step 3, after the wireless communication system receives the confirmation packet, the authentication between the wireless communication system and the mobile device succeeds, and they are switched to a signal transmission mode.

At step 4, the wireless communication system informs the mobile device that the mobile device can enter into a control mode. That is, the wireless communication system informs the mobile device that the mobile device can control the peripheral application device.

At step 5, the mobile device performs control of the peripheral application device.

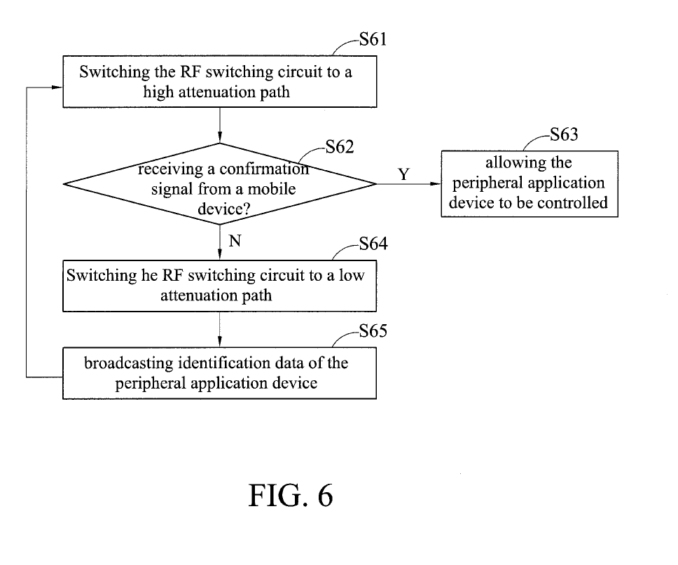

FIG. 6 is a schematic flow diagram showing switching of the RF switching circuit between an authentication phase and a control phase according to the present invention.

At step S61, the RF switching circuit is switched to a high attenuation path. In an embodiment, to establish a connection between devices within near distance, the frequency of a signal is attenuated to achieve near distance communication.

At step S62, whether there is a confirmation signal received from a mobile device is determined. A mobile device, if receiving an inquiry signal (an inquiry packet) with a lower frequency from a peripheral application device, can send a confirmation signal back to the peripheral application device so as to inform the peripheral application device that a connection can be established. The mobile device must be positioned close enough to the peripheral application device to receive the inquiry signal.

At step S63, the peripheral application device is allowed to be controlled. If the peripheral application device receives the confirmation signal from the mobile device at step S62, it means that a connection can be established between the peripheral application device and the mobile device. After authentication between the peripheral application device and the mobile device is completed, the peripheral application device informs the mobile device that the mobile device can perform control of the peripheral application device until the connection therebetween is terminated. During this process, the peripheral application device maintains the transmission mechanism of general wireless communication.

At step S64, the RF switching circuit is switched to a low attenuation path. If the peripheral application device does not receive a confirmation signal at step S62, it means that there is no mobile device nearby that wants to connect with the peripheral application device. To maintain normal operation of the original transmission mechanism of wireless communication of the peripheral application device, the RF switching circuit switches to a low attenuation path, i.e., the original transmission mechanism of wireless communication.

At step S65, identification data of the peripheral application device is broadcasted. As described at step S64, the RF switching circuit is switched to a low attenuation path and the peripheral application device returns to the original function. At this point, the peripheral application device broadcasts its identification data through the original transmission mechanism to look for a mobile device that wants to connect therewith. As such, any device, no matter how far away or close to the peripheral application device, can receive the inquiry packet.

Therefore, by utilizing the control mechanism of the wireless communication system and hardware and software integration of the RF switching circuit, the present invention can choose to attenuate the frequency of a transmission signal from the wireless communication system by a signal attenuation unit so as to achieve transmission of near distance communication, thus improving the transmission safety and preventing data leakage or eavesdropping. Further, signal attenuation is only performed during authentication. That is, the low power mode is used for authentication during an authentication phase. After authentication, the system switches to the normal power mode to perform transmission through the original transmission mechanism. Therefore, the wireless communication system according to the present invention is applicable to any wireless communication platform to achieve a low power communication function and a near distance transmission effect, thereby improving the authentication safety and achieving a quick response effect.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims

What is claimed is:

1. A wireless communication system using mimicked near field communication, wherein the wireless communication system is disposed in a peripheral application device and configured to be connected with a mobile device, the wireless communication system comprising:
a wireless communication module configured to send a control command; and
an RF switching circuit connected to the wireless communication module and configured to be switched to a low power mode or a normal power mode according to the control command,
wherein the RF switching circuit comprises a signal attenuation unit that attenuates a frequency of a transmission signal emitted from the wireless communication module when the RF switching circuit is switched to the low power mode and generates an output signal, and maintains the frequency of the transmission signal when the RF switching circuit is switched to the normal power mode.

2. The wireless communication system of claim 1, wherein the signal attenuation unit comprises a plurality of signal attenuators configured to provides different frequency attenuations to attenuate the transmission signal.

3. The wireless communication system of claim 1, wherein the RF switching circuit further comprises a first switcher disposed before the signal attenuation unit and configured to receive the transmission signal emitted from the wireless communication module.

4. The wireless communication system of claim 1, wherein the RF switching circuit further comprises a second switcher disposed after the signal attenuation unit and configured to output the transmission signal that already passes through the signal attenuation unit.

5. The wireless communication system of claim 1, wherein the output signal is transmitted to the mobile device through an antenna of the peripheral application device.

6. An authentication method of a wireless communication system using mimicked near field communication, wherein the wireless communication system is disposed in a peripheral application device and configured to be connected with a mobile device, the method comprising steps of:
switching the wireless communication system to a low power mode;
sending, by the wireless communication system, an inquiry signal when the wireless communication is switched to the low power mode;
receiving the inquiry signal, and sending, by the mobile device, a confirmation signal back to the wireless communication system;
receiving the confirmation signal, and switching the wireless communication system to a normal power mode; and
performing data transmission or control by the wireless communication system and the mobile device.

7. The authentication method of claim 6, wherein the wireless communication system is connected to the mobile device, the wireless communication system is switched between the low power mode and the normal power mode periodically.

8. The authentication method of claim 6, wherein the wireless communication system is not switched between the low power mode and the normal power mode periodically until the wireless communication system is not connected to the mobile device.

9. The authentication method of claim 6, wherein the wireless communication system comprises a signal attenuation unit configured to attenuate a frequency of a transmission signal emitted from the wireless communication system when the wireless communication system is switched to the low power mode.

10. The authentication method of claim 6, wherein the step of performing data transmission or control comprises changing the wireless communication system from an authentication phase to a control phase so as to allow the mobile device to control the peripheral application device.
